(19) United States
(12) Patent Application Publication
(10) Pub. No.: US 2019/0274462 A1
(43) Pub. Date: Sep. 12, 2019

(54) Pressure Cooker

(71) Applicant: NuWave LLC, Libertyville, IL (US)

(72) Inventor: Jung S. Moon, Long Grove, IL (US)

(21) Appl. No.: 16/298,024

(22) Filed: Mar. 11, 2019

Related U.S. Application Data
(60) Provisional application No. 62/640,721, filed on Mar. 9, 2018.

(51) Int. Cl. A47J 27/092; A47J 27/086; A47J 27/08

(52) U.S. Cl. CPC A47J 27/092; A47J 27/0802; A47J 27/0815; A47J 27/086

(57) ABSTRACT

A pressure cooker system having a cooking vessel, a removable pot, and a lid securable to the vessel. The lid is rotatable from a locked and fully-secured position to an unlocked and hinged position. The pressure cooker system also includes a plurality of locking flanges on an upper periphery of the open cooking vessel which correspond and interlock with a plurality of locking flanges on an interior periphery of the lid. A pressure indicator cooperates with a locking mechanism to prevent opening of the lid when the contents are under pressure. As an added safety feature, a pressure release gap located on one of the interlocking flanges prevents pressure build-up when the lid is not in the closed and locked position.

### RELATED APPLICATION(S)

The present application claims the filing priority of U.S. Provisional Application No. 62/640,721 titled “Pressure Cooker” and filed on Mar. 9, 2018.

### TECHNICAL FIELD OF THE INVENTION

The present invention relates to electric cooking appliances. Specifically, the invention relates to electric pressure cookers.

### BACKGROUND OF THE INVENTION

Pressure cookers, and particularly electric pressure cookers, have become more common in the preparation of family meals. Pressure cookers typically operate in the range of about 5 to 15 psi above atmospheric pressure. At an elevated pressure, the cookers are able to cook food more quickly than conventional methods of cooking, using only steam. The process is fairly simple: Increased pressure in the pressure cooker allows vapor in the sealed pot to rise above its usual maximum temperature (e.g., >100° C. for water vapor), making pressure cooking faster than, for example, baking, steaming, or boiling methods. The pressure also helps infuse the vapor into the food, which creates more flavorful dishes when using liquids such as wine or beef stock. Thus, pressure cookers can provide better tasting food while saving both time and energy.

Pressure cookers typically consist of a pot and a lid. Both stovetop and electric pressure cookers are currently available. Pressure cookers are designed to be essentially airtight so that steam pressure can build within the vessel. To this end, the lid is locked onto the pot using cooperating flanges on both the pot and lid. A gasket, typically rubber or silicone, is positioned about the periphery of where the lid and pot meet, and ensures that steam from the pot does not escape from the vessel during cooking. The lid includes a lock, which may be in the handle, to secure the lid onto the pot. A pressure indicator on the lid indicates when the vessel has reached operating pressure. Pressure cookers also generally have a safety vent that automatically releases steam to prevent pressure build-up in the vessel above the designed cooking pressure.

After using a pressure cooker, the pressure must be safely released so that the cooker may be safely opened. Current methods for releasing or reducing pressure in the pressure cooker include passively allowing the pressure cooker to cool, or for stovetop cookers, running cold water over the pressure cooker to cool the vessel.

In addition, many pressure cookers are equipped with a quick pressure release valve that requires a user to manually release any remaining pressure in the vessel after cooking, typically by turning a valve that releases steam. Unfortunately, this can sometimes result in burning a user's finger or hand from the steam inside the cooker. The pressure cooker of the present invention provides a pressure release valve that does not require that the user's hands be in the vicinity of escaping steam.

Due to the pressure and steam, care must be taken to make sure the lid is fully locked onto the pot to avoid potentially hazardous situations. An unsecured lid can lead to serious injury if the lid were to suddenly jettison from the pot due to the pressure. To avoid such dangers, the present invention provides a safety feature which prevents the build-up of pressure when the lid is not fully locked to the pot.

Another safety feature includes a mechanism which prevents the lid from being removed from the pot until the pressure in the cooker has reduced to near atmospheric levels. This safety feature includes a visible indicator that rises when the cooker is pressurized and lowers when it is not. When in the raised position, the safety feature does not permit the lid to be removed from the pot. However, in prior art pressure cookers, users have circumvented this feature by merely pressing on the indicator to force it into a lowered position. The present invention provides a pressure cooker that inhibits a user from circumventing this important safety feature.

Until the invention of the present application, these and other problems in the prior art went either unnoticed or unsolved by those skilled in the art. The present invention provides an electric pressure cooker with multiple safety functions without sacrificing effectiveness or affordability.

### SUMMARY OF THE INVENTION

There is disclosed herein an improved electric pressure cooker system which avoids the disadvantages of prior devices, methods and systems while affording additional structural and operating advantages.

Generally speaking, the pressure cooker system comprises a cooking vessel, a removable cooking pot, and a lid securable to the cooking vessel. The cooking vessel includes a control panel, a heating plate at a bottom of a cooking cavity, and an electric power cord which connects to a power source, while the removable cooking pot is configured to be positioned within the cooking cavity and contacting the heating plate. The lid completely encloses the cooking cavity, and is movable from a locked position, wherein the lid is fully secured to the vessel in a closed orientation, to an unlocked position, wherein the lid is pivotable at a hinge point between an open orientation and the closed orientation.

In specific embodiments, at least one first locking flange is positioned about a periphery of an open end of the cooking cavity and at least one second locking flange positioned about a periphery of an internal surface of the lid, wherein the at least one second locking flange is operatively engageable with the at least one first locking flange to secure the lid to the cooking vessel in the closed orientation. A pressure release gap is located in either one of the at least one first locking flange or the at least one second locking flange, wherein the release gap is open to release pressure from the pressure cooker when the lid is in the closed orientation but not in the locked position.

In at least one specific embodiment, the lid rotates to move from the locked position to the unlocked position. The lid further comprises a visual pressure indicator which activates when an increased pressure is achieved in the cooking vessel. A locking mechanism prevents movement of the lid to an unlocked position when the pressure indicator is activated. Preferably, the visual pressure indicator comprises tamper-proofing to prevent bypassing the locking mechanism. The tamper-proofing comprises at least one of either a cage or grill covering the visual pressure indicator or a recess in the lid which houses the visual pressure indicator.

In further embodiments, the pressure cooker includes a pressure release valve having an open and a closed position. It further includes a pressure release activation switch to place the pressure release valve in an open position, and a pressure release de-activation switch to place the pressure release valve in a closed position.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a perspective view of an embodiment of a pressure cooker system, including illustration of a lid in a removed state, in accordance with the present disclosure;

FIG. 2 is a top perspective view of an embodiment of the disclosed pressure cooker system showing the lid in an open orientation and the pot removed;

FIG. 3 is a top view of an embodiment of the cooking plate in the bottom of the cooking cavity;

FIG. 4 is a top view of an embodiment of a connector on the cooking vessel as a portion of a hinge for the lid of the pressure cooker system of FIG. 1;

FIG. 5A is close up view of an embodiment of the disconnected hinge for the lid of the pressure cooker system of FIG. 1;

FIG. 5B is a close up of the inset from FIG. 5A showing an embodiment of the channel connector on the lid;

FIG. 6 is a close up view of a partial connection between the lid and cooking vessel to form a hinge;

FIG. 7 is another close up view showing the nearly complete connection between the lid and cooking vessel as they are slid together to form a hinge;

FIG. 8 is a close up view of the completed hinge between the lid and cooking vessel with the lid in an open orientation; and

FIG. 9 is a close up view of the completed hinge with the lid in a closed orientation.

FIG. 10 is a front view showing an embodiment of the control panel;

FIG. 11 is a close up view of an embodiment of the underside of the lid;

FIG. 12 is a partial view of an embodiment of the upper surface of the lid;

FIG. 13 is another view of an embodiment of the underside of the lid;

FIG. 14 is another partial view of an embodiment of the top surface of the lid;

FIG. 15 is a close up view of an embodiment of the “locked” and “unlocked” positions for the rotating lid;

FIG. 16A is a perspective view showing the removal of the pot from the pressure cooker system of FIG. 1;

FIG. 16B is a close up view of an embodiment of the inside surface of the cooking pot illustrating the graduated markings;

FIG. 17 is a close up view of an embodiment of the first locking flanges of the pressure cooker system; and

FIG. 18 is a close up view of an embodiment of the second locking flanges of the pressure cooker system.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

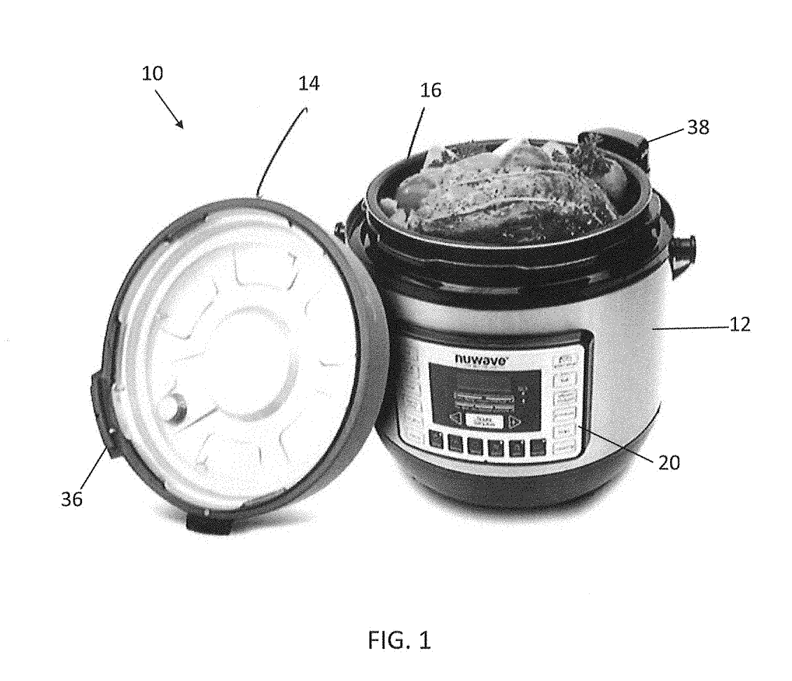

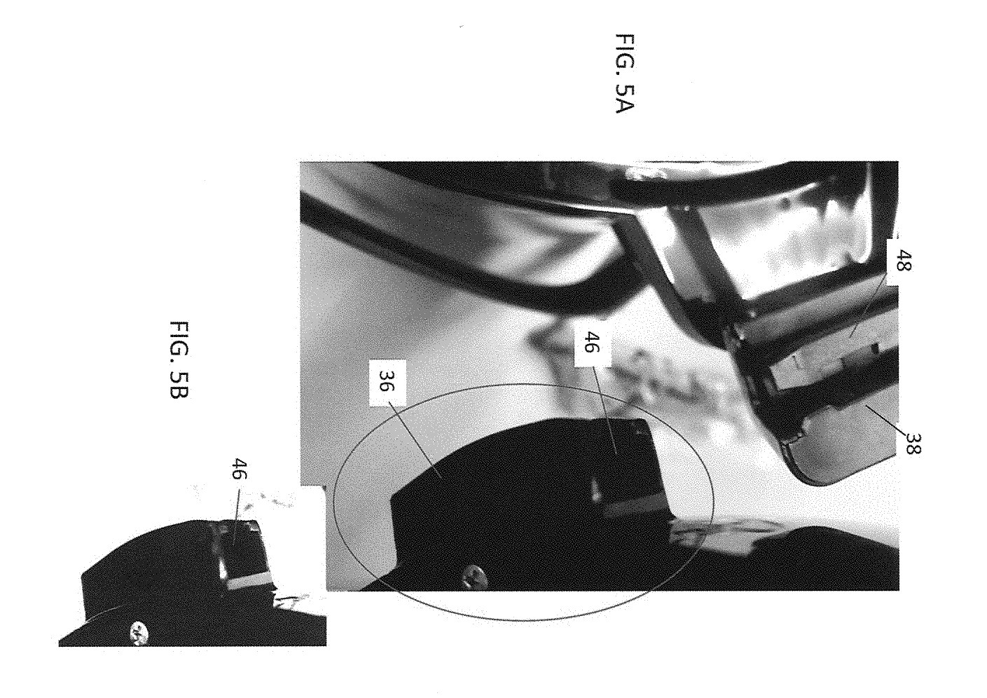

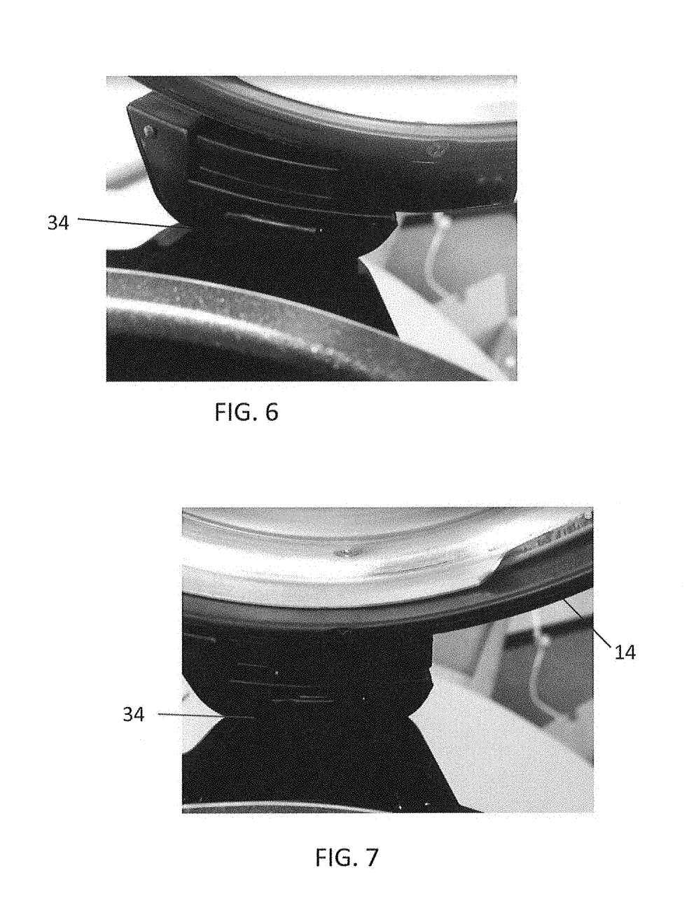

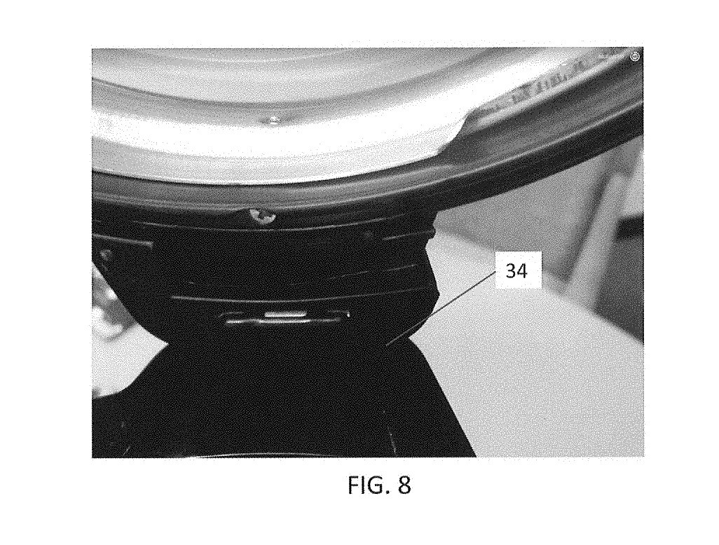

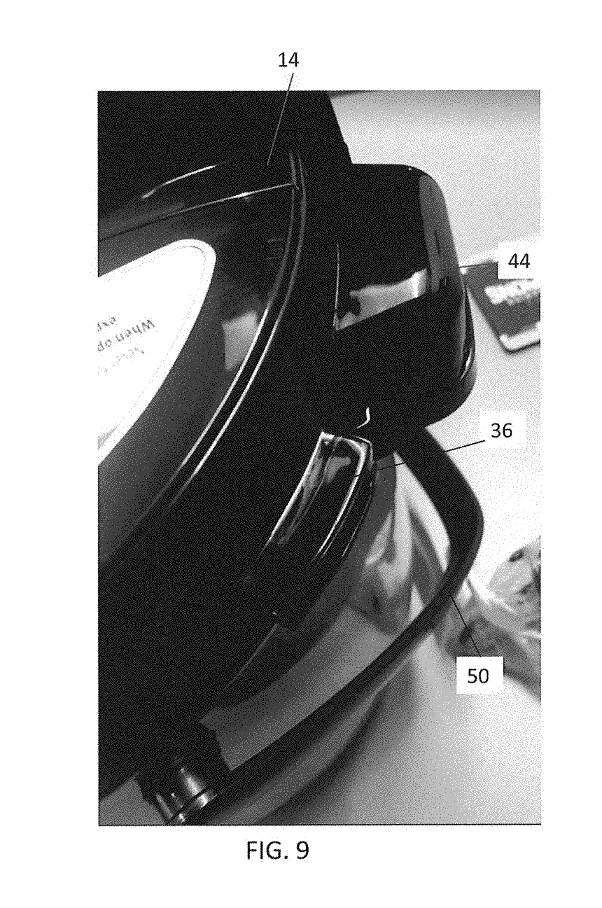

Referring to FIGS. 1-18, there are illustrated embodiments of a pressure cooker system generally designated by the numeral 10. The pressure cooker system 10 includes a cooking vessel 12, a lid 14 and a removable cooking pot 16. The cooking vessel 12 includes a control panel 20, a cooking cavity 22 with a heating plate 24 at the bottom, and an electric power cord 26 which connects to an AC power source (not shown). The lid 14 is securable to the cooking vessel 12 to enclose the cooking cavity 22.

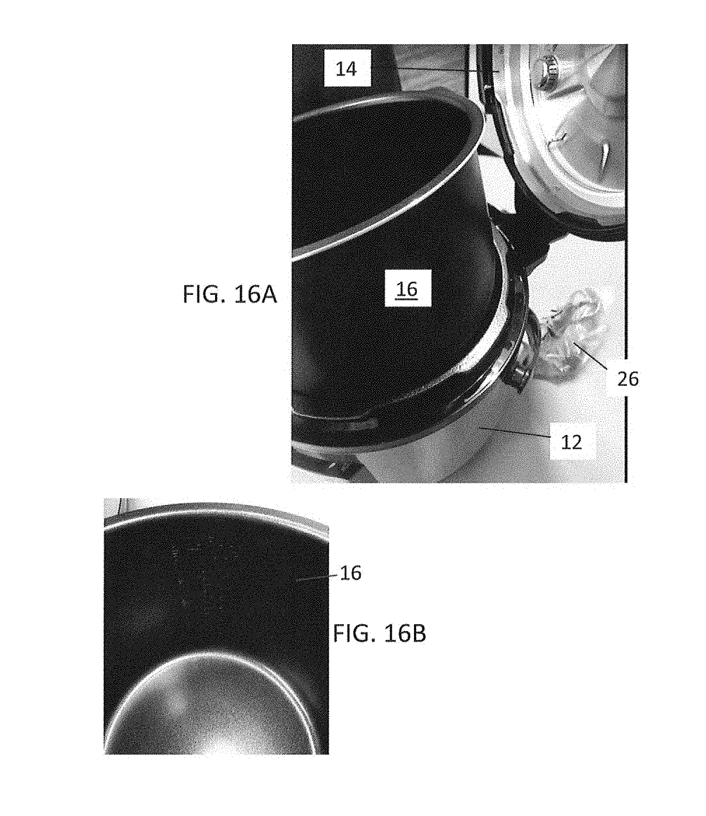

Preferably, the cooking vessel 12 and the lid 14 are made substantially of stainless steel and/or aluminum. However, other suitable material which can meet the necessary heat and pressure requirements may be used as well. For household use, the cooking pot 16 is typically a six to ten quart capacity, but can be manufactured to any desired size, as needed. Preferably, the pot 16 is graduated, as shown in FIG. 16B, to facilitate measuring and insuring that the proper amount of liquid is used for pressure cooking.

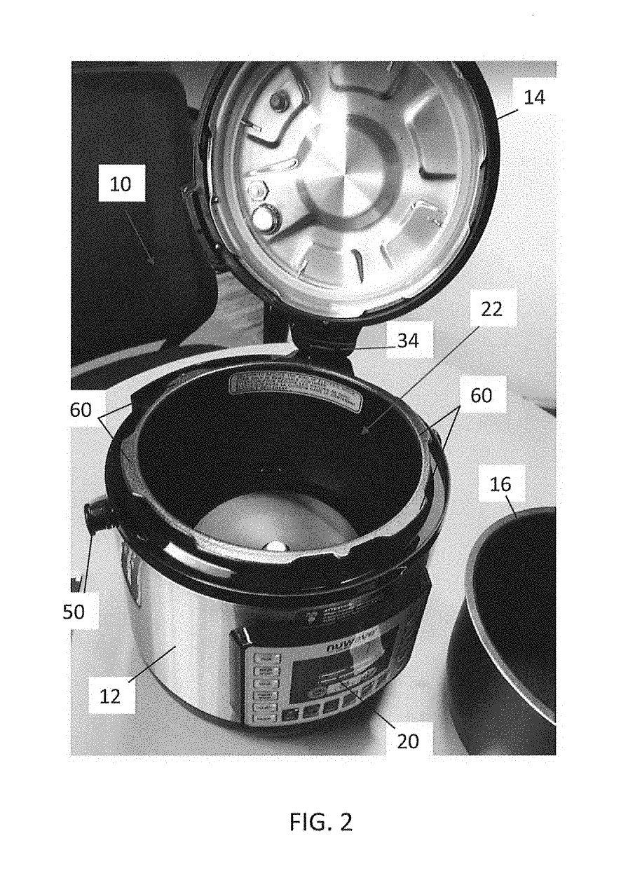

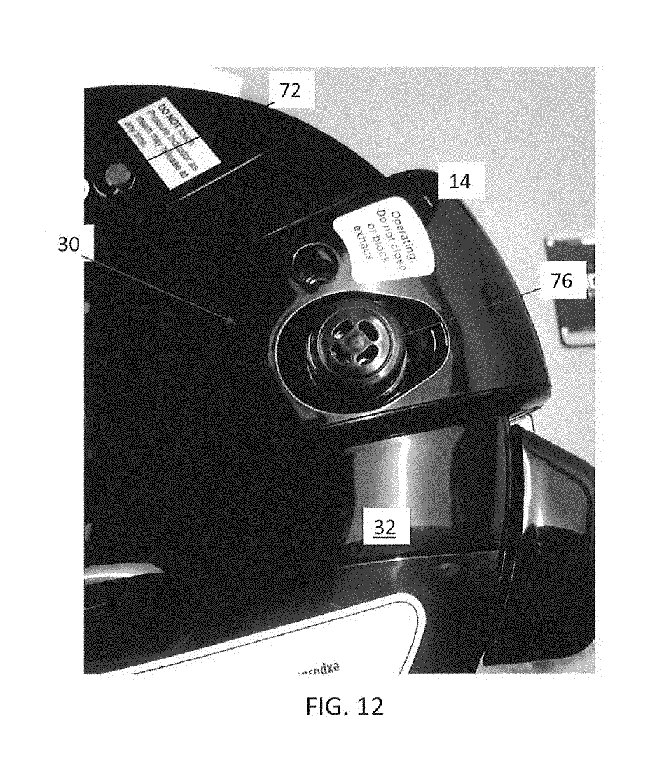

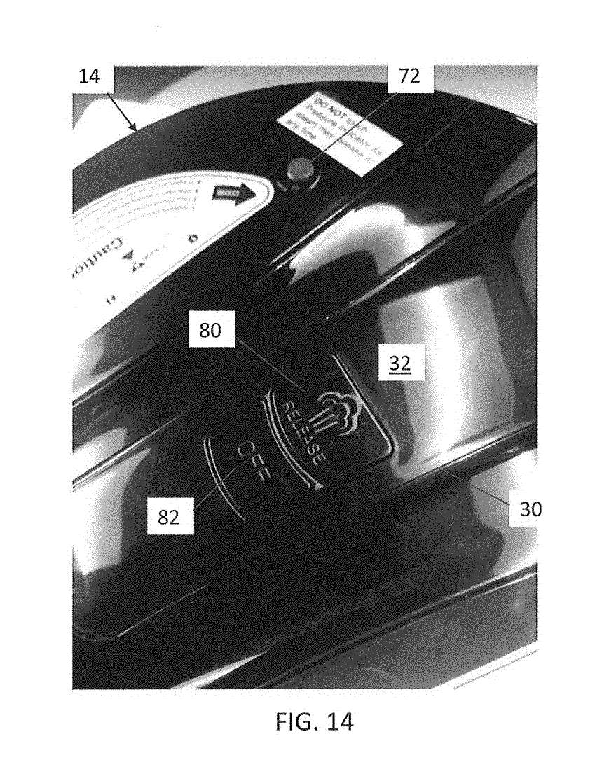

As illustrated in FIGS. 1 and 2, the lid 14 is configured to cover the open end of the cooking vessel 12. A handle 30 is preferably molded into the top surface 32, as shown in FIGS. 12 and 14, to provide the user with an easy gripping surface for moving the lid 14.

FIGS. 4-9 illustrate connection of the lid 14 to the cooking vessel 12. While the lid 14 connects to the cooking vessel 12 via a hinge 34 formed between a first connector 36 on the lid 14 and a second connector 38 on the cooking vessel 12, it is capable of being rotated about a vertical axis between a locked position 40 and an unlocked position 42. The hinge point 44 is where the two connectors, 36 and 38, are brought together when the lid 14 is rotated to the unlocked position. The hinge point 44 allows the lid 14 to be pivoted between an open orientation and a closed orientation. As shown, the first connector 36 includes a channel 46 which slides onto the rib 48 of the second connector 38 on the vessel 12 to form hinge 34.

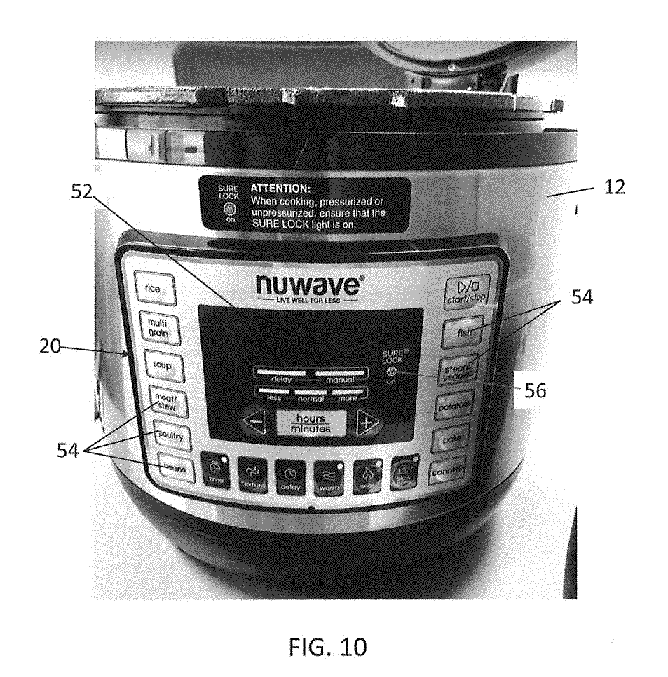

The cooking vessel 12 may also include a convenient handle 50 to facilitate carrying of the pressure cooker system 10 when not in use. The control panel 20 is shown in FIG. 10 as being prominently positioned on a front surface of the cylindrical cooking vessel 12 and includes a display 52 and several programmable and preset buttons 54. In addition to the digital display 52, as an additional safety feature, an indicator light 56 is activated by a switch 58 on the cooking vessel rim when the lid 14 is properly closed and locked.

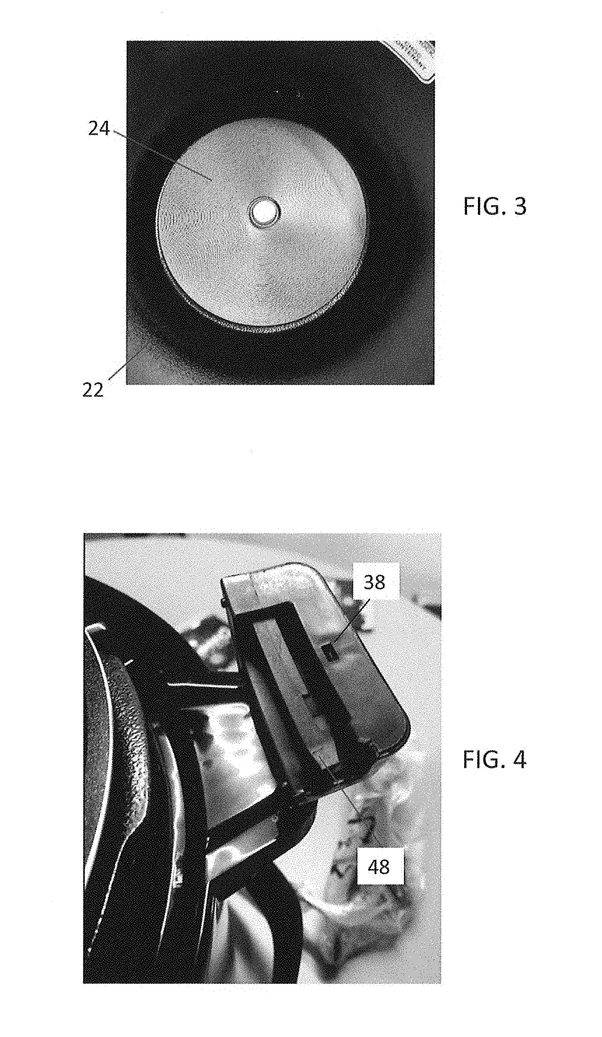

Referring to FIGS. 2 and 3, the inside of the cooking vessel 12 is shown where the cooking pot 16 fits securely within the cooking cavity 22 and contacts the heating plate 24 positioned at the bottom of the cavity 22. As previously mentioned, FIGS. 16A and 16B show the cooking pot 16 having graduated markings to make filling to the right level easier for a user.

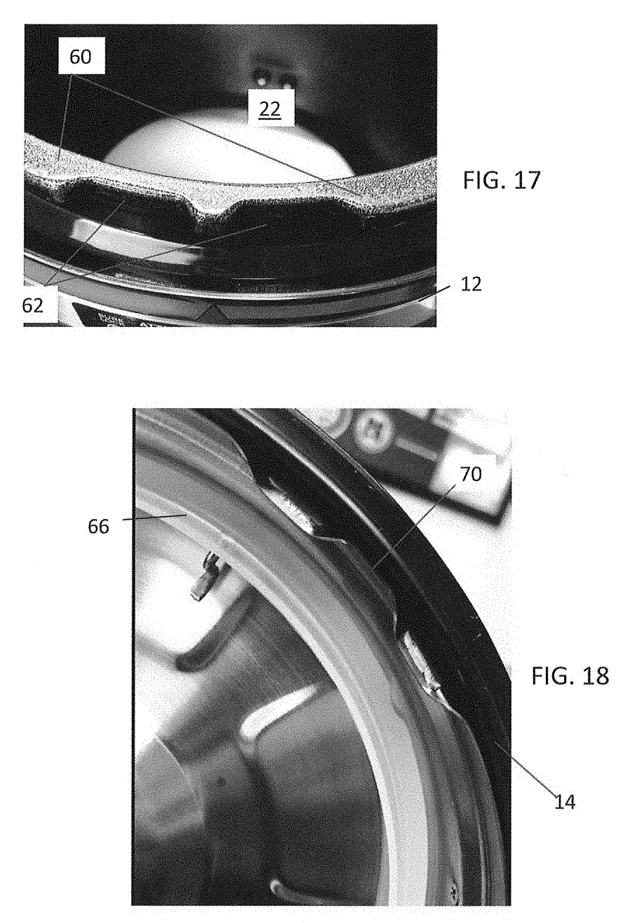

As shown in FIGS. 2 and 17, a plurality of first locking flanges 60 are spaced about a periphery of the vessel opening. The first locking flanges 60 are preferably integral to the cooking vessel 12 and extend outward along the outer circumference of the pot 12, separated by open spaces 62.

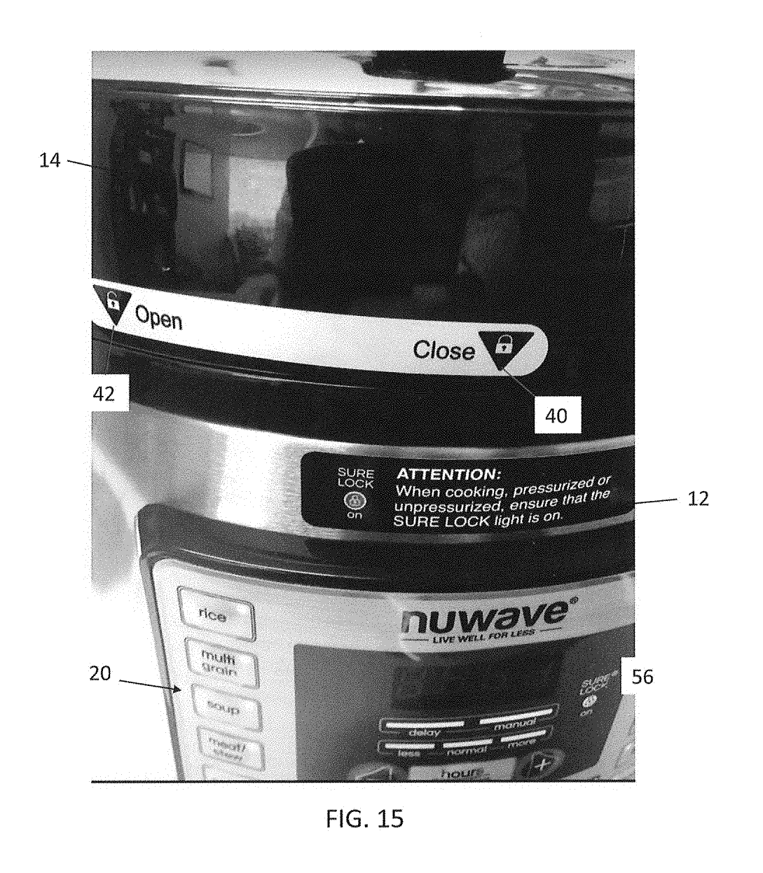

As illustrated in FIGS. 2, 13, and 18, the lid 14 includes a plurality of second locking flanges 64 spaced about the periphery of an interior edge. The plurality of second locking flanges 64 operatively engage the plurality of first locking flanges 60 to secure the lid 14 to the cooking vessel 12. The second locking flanges 64 are preferably integral to and extend inward along an inner circumference of the lid 14. Each of the second locking flanges 64 can be arched in a generally upward direction to better secure the lid 14 when engaged. When the lid 14 is connected to the vessel 12 via hinge 34, the first locking flanges 60 are aligned with the spaces between the second locking flanges 64—i.e., the unlocked position—to allow the lid 14 to pivot between the closed and open orientations, as illustrated in FIG. 15. Conversely, when the lid 14 is rotated to align the first locking flanges 60 with the second locking flanges 64, the lid 14 is in the locked position. A gasket 66 extends around an inner circumference of the lid 14 and seals against the cooking vessel 12 to prevent steam from escaping the pressure cooker 10 during cooking. The gasket 66 can be made of rubber, silicone or any suitable material.

With prior art pressure cookers, research has shown that users will, on occasion, misalign the lid of the pressure cooker resulting in an incomplete locking to the cooking vessel. This condition has the potential for causing serious injury to a user due to an explosive discharge of pressure. In an embodiment of the present pressure cooker system 10, pressure is prevented from building up when the lid 14 is not completely secured to the pot 12.

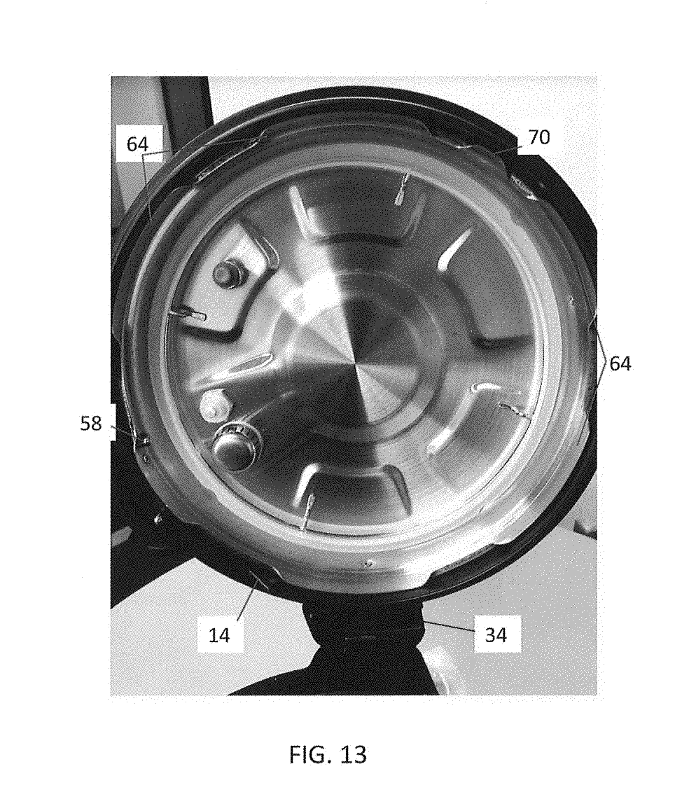

As shown in FIGS. 13 and 18, a pressure release gap 70 is provided in the plurality of second locking flanges 64 on the lid 14. The pressure release gap 70 is designed to vent steam from the cooking pot 16 when the lid 14 is misaligned. The gap 70 is in the range of about one-quarter inch to about three-quarters inch in length, but greater or smaller lengths may be sufficient for other applications and depending on the size of the pressure cooker system 10 and the relative orientations of the locking flanges 60 and 64. While shown in the plurality of second locking flanges 64, the pressure release gap 70 can be alternatively located in the first locking flanges 60 of the vessel 12 or in both first and second locking flanges, 60 and 64.

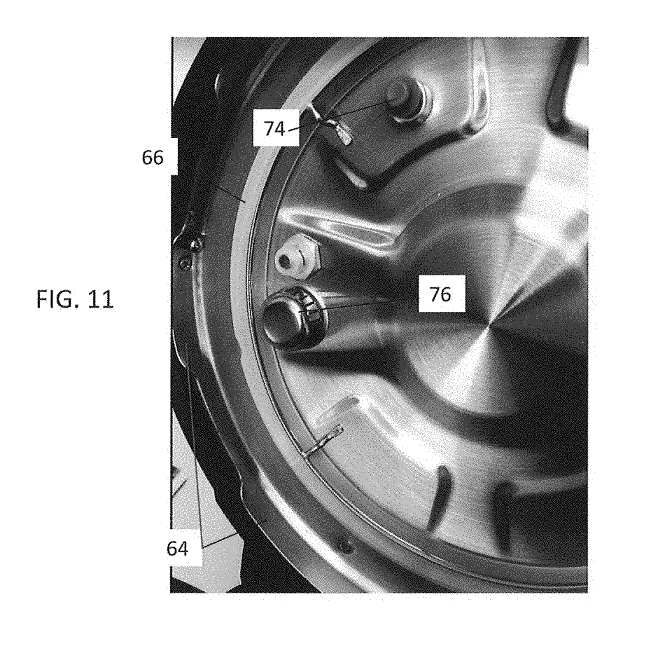

Referring to FIGS. 11-14, other features of the present pressure cooker system 10 are illustrated. For example, a visual pressure indicator 72 is located on the lid 14. The visual pressure indicator 72 is activated when the cooker 10 is pressurized, and when the cooker 10 is not pressurized, the visual pressure indicator 72 is deactivated. Preferably, the visual pressure indicator includes a floating pin 74 which is extended upward from the lid 14 when the cooker 10 is at operating pressure. When activated, the pressure indicator 72 prevents the lid 14 from being rotated to an unlocked position.

The pressure cooker system 10 further includes a steam release valve 76. As a safety feature, when the steam release valve 76 releases the pressure within the cooking vessel 12 to a safe level, the visual indicator 72 deactivates, dropping the pin 74 to a lowered position, thereby allowing the lid 14 to be rotated by a user to an unlocked position to open the cooker 10.

To prevent a user from trying to circumvent this safety feature, the present pressure cooker system 10 is designed with a tamper-proofing feature. While prior art cookers allow a user to press the pressure indicator into a lowered position, using a finger or a utensil, the present pressure cooker system 10 prevents such tampering.

Accordingly, in an embodiment, the present system 10 includes a guard over the visual pressure indicator 72 to prevent such tampering. The guard can be a grid or other suitable shape that allows the user to view the indicator 72 but not easily access it manually, or with a utensil. By recessing the indicator into the surface of the lid 14, a similar result can be achieved.

Finally, in prior art pressure cookers, the user is required to rotate a steam release valve to allow steam to escape the cooker. This places the user's hand near the escaping steam and can potentially result in steam injury to the user. Accordingly, in another embodiment of the present pressure cooker system 10, a pressure release activation switch 80 is positioned away from the release valve 76. The pressure release activation switch 80 causes the pressure release valve 76 to tilt upward to an open position, opening it to release pressure from the cooking vessel 12. The valve 76 stays open after a user presses the activation switch 80. When the visual pressure indicator 72 deactivates (i.e., the vessel 12 is no longer pressurized), the user then presses a pressure release de-activation switch 82 to close the pressure release valve 76.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A pressure cooker system comprising:
a cooking vessel having a control panel, a heating plate at a bottom of a cooking cavity, and an electric power cord which connects to a power source;
a removable cooking pot configured to be positioned within the cooking cavity and contacting the heating plate;
a lid securable to the cooking vessel to completely enclose the cooking cavity, the lid being movable from a locked position, wherein the lid is fully secured to the vessel in a closed orientation, to an unlocked position, wherein the lid is pivotable at a hinge point between an open orientation and the closed orientation;
at least one first locking flange positioned about a periphery of an open end of the cooking cavity;
at least one second locking flange positioned about a periphery of an internal surface of the lid, wherein the at least one second locking flange is operatively engageable with the at least one first locking flange to secure the lid to the cooking vessel in the closed orientation; and
a pressure release gap located in either one of the at least one first locking flange or the at least one second locking flange, wherein the release gap is open to release pressure from the pressure cooker when the lid is in the closed orientation but not in the locked position.

2. The pressure cooker system of claim 1, wherein the lid rotates to move from the locked position to the unlocked position.

3. The pressure cooker system of claim 1, wherein the lid further comprises a visual pressure indicator which activates when an increased pressure is achieved in the cooking vessel.

4. The pressure cooker system of claim 3, further comprising a locking mechanism which prevents movement of the lid to an unlocked position when the pressure indicator is activated.

5. The pressure cooker system of claim 4, wherein the visual pressure indicator comprises tamper-proofing to prevent bypassing the locking mechanism.

6. The pressure cooker system of claim 5, wherein the tamper-proofing comprises at least one of a cage covering the visual pressure indicator or a recess housing the visual pressure indicator.

7. The pressure cooker system of claim 1, wherein the control panel comprises an indicator when the lid is properly in a closed orientation and locked position.

8. The pressure cooker system of claim 1, wherein the pressure release gap is positioned in the at least one first locking flange.

9. The pressure cooker system of claim 1, wherein the pressure release gap is positioned in the at least one second locking flange.

10. A pressure cooker system comprising:
a cooking vessel having a control panel, a heating plate at a bottom of a cooking cavity, and an electric power cord which connects to a power source;
a removable cooking pot configured to be positioned within the cooking cavity and contacting the heating plate;
a lid securable to the cooking vessel to completely enclose the cooking cavity, the lid being rotatable about a vertical axis from a locked position, wherein the lid is fully secured to the vessel in a closed orientation, to an unlocked position, wherein the lid is pivotable from a hinge point between an open orientation and the closed orientation;
a visual pressure indicator positioned on the lid which activates when an increased pressure is achieved in the cooking vessel;
a locking mechanism which prevents movement of the lid to an unlocked position when the pressure indicator is activated;
a plurality of first locking flanges positioned about a periphery of an open end of the cooking cavity;
a plurality of second locking flanges positioned about a periphery of an internal surface of the lid, wherein the plurality of second locking flanges correspond to and operatively engage with the plurality of first locking flanges to secure the lid to the cooking vessel in the closed orientation; and
a pressure release gap located in either one of the plurality of first locking flanges or the plurality of second locking flanges, wherein the release gap is open to release pressure from the pressure cooker when the lid is in the closed orientation but not in the locked position.

11. The pressure cooker system of claim 10, wherein the visual pressure indicator comprises tamper-proofing to prevent bypassing the locking mechanism.

12. The pressure cooker system of claim 11, wherein the tamper-proofing comprises at least one of a cage covering the visual pressure indicator or a recess housing the visual pressure indicator.

13. The pressure cooker system of claim 10, wherein the control panel comprises an indicator when the lid is properly in a closed orientation and locked position.

14. The pressure cooker system of claim 10, wherein the pressure release gap is positioned in at least one of the plurality of first locking flanges.

15. The pressure cooker system of claim 10, wherein the pressure release gap is positioned in at least one of the plurality of second locking flanges.
